(19) United States
(12) Patent Application Publication
(10) Pub. No.: US 2020/0252269 A1
(43) Pub. Date: Aug. 6, 2020

(54) METHOD FOR CONFIGURING A CENTRAL CONTROL UNIT BELONGING TO A HOME AUTOMATION SYSTEM

(71) Applicant: OVERKIZ, METZ-TESSI (FR)

(72) Inventor: Sylvain POGNANT, SEYNOD (FR)

(21) Appl. No.: 16/621,582

(22) PCT Filed: Jun. 7, 2018
(86) PCT No.: PCT/FR2018/051321

§ 371 Date: Apr. 10, 2020

(30) Foreign Application Priority Data
Jun. 14, 2017 (FR) 17/55373

(51) Int. Cl. H04L 12/24; H04L 12/28

(52) U.S. Cl. CPC H04L 41/084; H04L 12/2807; H04L 41/085

(57) ABSTRACT

The present invention relates to a method for configuring a second central control unit (U1′) belonging to a home automation system (Su), when there is a need to replace a first central control unit (U1), and comprising the following steps: registering (ERSvc1) at least one set of configuration data or instructions (cfg) associated with a first central control unit; receiving (ERSvc7) a configuration request from a second central control unit (U1′); determining (ERScv8) an association between the second central control unit (U1′) on the one hand and the first central control unit (U1) on the other hand; determining (ERSvc10, ERSvc5) at least one set of configuration data or instructions (cfg′) associated with the second central control unit (U1′); sending (ERSvc11) at least one configuration message (MCfg) comprising the at least one set of configuration data or instructions (cfg′) associated with the second central control unit (U1′).

### FIELD OF THE INVENTION

The present invention concerns a method for configuring at least one central control unit or a home automation device belonging to a home automation installation.

### PRIOR ART

so A home automation installation of a building may comprise one or several home automation device(s). It is known to proceed with the monitoring, that is to say the control and/or the supervision of said installation using a central control unit which communicates with one or several home automation device(s). Such a central control unit may be integrated to a home automation device or be independent.

A central control unit has to be configured to enable its interaction with the home automation device(s) or remote functional service(s), such as for example a user service.

A large number of different configurations may be considered for the same central control unit, which implies implementing a configuration method adapted in particular according to the devices or services to be connected, or proceeding with a configuration in situ during the set-up of the central control unit in the home automation installation, this configuration may turn out to be complex.

When a central control unit has to be replaced because of a failure or to install a new model, this unit has to be configured again to adapt it to the installation and to enable its operation.

The present invention aims at solving all or part of the above-mentioned drawbacks.

### DISCLOSURE OF THE INVENTION

To this end, the present invention concerns a method for configuring a second central control unit belonging to a home automation installation, in the context of the replacement of a first central control unit, the method being implemented by a first configuration remote access service executed by a management unit and comprising the following steps:
Registration of at least one set of configuration data or instructions associated to a unique identifier of a first central control unit;
Reception of a configuration request linked to an identifier of a second central control unit;
Determination of an association between the second central control unit or its identifier on the one hand and the first central control unit or its identifier on the other hand;
Determination of at least one set of configuration data or instructions associated to the identifier of the second central control unit from the at least one set of configuration data or instructions associated to the unique identifier of the first central control unit;
Sending at least one configuration message comprising the at least one set of configuration data or instructions associated to the identifier of the second central control unit to the second central control unit.

Thanks to the arrangements according to the invention, a replacement central control unit may be configured by taking on the configuration of the previous central control unit. This replacement may intervene in case of failure, or in case of replacement with a new model of central control unit. The replacement central control unit may be configured in a minimal or generic way in factory and during its distribution. During the initial operation of this central unit, the adequate configuration, corresponding to a configuration derived from the configuration of the first central unit is obtained from the configuration service. For example, these arrangements allow configuring the communication with at least one home automation device present in the home automation installation, the communication with a particular user service for control and/or supervision. They also allow proceeding with a geographical adaptation of the communication frequency bands, to communicate in authorized frequency bands depending on the geographical area. It is also possible to proceed with a configuration of the functional offering of the central control unit or of the home automation device, or with the configuration of the human-machine interface. The configuration may also comprise a download of a software component or of a software component portion to be executed on the central control unit.

Thus, the configuration of the replacement central control unit is greatly simplified.

In the context of the present invention, a home automation device is a home automation equipment and/or a sensor, or else a portion of a home automation equipment or a portion of a sensor corresponding to a functional subset. A home automation device may also correspond to a control point of other home automation devices.

In the context of the present invention, an installation is a set comprising a plurality of home automation devices and at least one central control unit arranged within one single building or on a plurality of locations, each home automation device being connected to an electronic control unit among the plurality of electronic control units, the plurality of electronic control units forming a group under the control of a user. The electronic devices form groups of at least one home automation device attached to an electronic control unit.

In the context of the present invention, a central control unit of the home automation installation is an electronic unit comprising:
at least one processing unit to contain and execute at least one computer program,
at least one communication module intended for the monitoring and/or control of at least one home automation device; and
at least one module for communication with the management unit.

The electronic unit may be independent from or integrated into a home automation device. In this last case, the communication module intended for the monitoring and/or control of the device may be a communication module internal to the home automation device and/or a communication module intended for the monitoring and/or control of other home automation devices. In some applications, a central control unit may communicate with the management unit through an intermediate management unit, for example a third-party service provider, whose intermediate management unit provides a service interface or API (standing for “Application Program Interface”).

The central control unit may also be integrated to a router and/or a modem achieving a connection to a wide area network, in particular the Internet.

In the context of the present invention, a configuration service is intended to identify the correct technical configuration for the home automation device or the considered central control unit and to communicate configuration information to the central control unit. This service may correspond to a remote access service or to a user service intended for the monitoring and/or control and/or supervision of the home automation installation by a user or by an application. This service may be a remotely-accessible computerized service. This service may enable access to at last one control or supervision function of a home automation installation or of a home automation device, by means of a user interface or an application. The user interface may be accessible by a graphical interface, or through a programming interface.

By user, it should be understood an end user, an installer or a maintenance operator.

According to an aspect of the invention, the management unit executing the remote service is a server remotely connected to the at least one home automation installation via a wide area network. It should be noted that the term server is a logical designation which may cover the use of several physical servers to distribute the computer processing load to be carried out.

According to another aspect of the invention, the management unit(s) executing the first configuration service may be a central unit intended to be connected to one or several central control unit(s) on distinct private or local area networks, or else on the same local area network.

In general, the supervision corresponds to a supervision based on the processing of values of the state variables of at least one home automation device or one central control unit.

In the context of the present invention, a state variable is an element describing the state of a home automation device. The value of a state variable may correspond to the ON/OFF condition for a switch, or to an opening degree or percentage for a shutter. Moreover, a state variable may correspond to a measurement value of a sensor, for example a value of a physical or environmental quantity. The description of the states of the devices may be generic or specific, depending on the local protocol. The identifiers of the state variables may be numeric or alphanumeric. The values of the state variables may use formats or scales which are customized or proprietary.

In the context of the present invention, a command corresponds to an order that may be given to a home automation device or to a central control unit in order to carry out an action by a device or to obtain an information feedback, for example an information relating to a state variable of this device.

In the context of the present invention, a message is an information element notified or received via a communication module from an external equipment, or in the form of a synchronous or asynchronous call, which may also correspond to a local or remote function call.

According to an aspect of the invention, the obtainment of the location identifier is carried out by collecting this identifier in the memory of the central control unit. This identifier may be stored in the memory during a pre-configuration, for example carried out in factory. Alternatively, this identifier may be communicated by the user.

According to one implementation, the method comprises a prior step of plugging or initializing the central control unit.

This plugging/initialization may be trigged by an electric power supply or by an order originating from an instruction of the user through a physical action on the central control unit such as a press on a button or a sending of instruction via a terminal.

According to an aspect of the invention, the sending of the configuration request may correspond to an attempt to connect to the configuration service. This connection attempt identifies the central control unit by the identifier.

According to an aspect of the invention, in an initial or prior phase of the replacement method, the central control unit communicates its configuration in the form of at least one set of configuration data and/or instructions to the configuration service.

These steps may be carried out at will during a backup operation carried out at the end of the configuration of the central control unit, and/or periodically with updates of the stored data. It is also possible that these steps are possibly initiated before a replacement in the case of installation of a new model of central control unit.

In general, the configuration request step intervenes after a failure or a disabling of the first central control unit. The disabling may correspond to an expected installation of a new model of central control unit.

The step of determining at least one set of configuration data or instruction associated to the identifier of the second central control unit from the at least one set of configuration data or instruction associated to the unique identifier of the first central control unit may be carried out subsequently or partially or totally prior to the step of receiving a configuration request.

According to an aspect of the invention, the step of determining an association between the second central control unit or its identifier on the one hand and the first central control unit or its identifier on the other hand comprises a step of checking up in a configuration repository in order to determine whether the identifier of the second central control unit is assigned.

The recognition of the assignment of the identifier of the second central control unit may be a requisite for the determination of at least one set of configuration data or instructions associated to the identifier of the second central control unit. Otherwise, this means that the configuration request cannot be addressed because the replacement request has not been registered. Hence, a valid replacement should be determined before resuming the configuration.

According to an aspect of the invention, the configuration request originates from the second home automation device.

According to another aspect of the invention, the configuration request may originate from a user. In particular, the user may act using a user interface or through a mobile terminal. Thus, the user can connect on the configuration service and trigger the replacement of the first central control unit with the second central control unit by providing two identifiers of the first and of the second central control unit. In particular, this step may be carried out following the plugging and/or the initialization of the second central control unit.

According to an aspect of the invention, the at least one set of configuration data or instructions associated to the identifier of the second central control unit comprises at least one datum or instruction for configuring at least one emission and/or reception address of the second central control unit used for a communication interface with a home automation device of the home automation installation.

Thanks to these arrangements, the configuration of at least one emission address enables a direct communication in emission with a home automation device whose address was known to the previous central control unit and which is taken on by the new central control unit.

A home automation device that is related to the central control unit, such as for example a lamp, and communicating with the central control unit may store an address corresponding to the ancient central control unit for example in order to be able to send notifications to said central control unit.

Thanks to the configuration of the reception address of the new central control unit which takes on the reception address of the previous central control unit, a direct communication is enabled between the device and the central control unit because the value of the address of the ancient central control unit is assigned to the new central control unit.

According to an aspect of the invention, the communication interface is related to communication according to at least one communication protocol.

According to an aspect of the invention, the configuration step may comprise several steps of configuring several addresses corresponding for example to a plurality of communication interfaces using a plurality of distinct communication protocols.

According to an aspect of the invention, the address value(s) are part of the at least one set of configuration data or instructions originating from the first configuration remote service.

According to an aspect of the invention, the at least one set of configuration data or instructions associated to the identifier of the second central control unit comprises at least one datum or instruction for configuring an emission and/or reception address used by a communication interface of a home automation device related to the central control unit of the home automation installation.

Thanks to these arrangements, the configuration of at least one emission address in the device enables the home automation device to communicate in emission with the new central control unit.

A home automation device that is related to the central control unit, such as for example a lamp, and communicating with the central control unit may store an address corresponding to the central control unit for example in order to be able to send notifications to said central control unit.

Similarly, it is possible to modify a reception address for example to authorize the new central control unit to send commands to the home automation device.

According to an aspect of the invention, the method further comprises the following steps:
Reception of a replacement request in connection with an identifier of the first central control unit and an identifier of the second central control unit;
Registration in a configuration repository of an association between the first central control unit or its identifier on the one hand and the second central control unit or its identifier on the other hand.

According to an aspect of the invention, the replacement request originates from a user, for example through a user terminal.

In the case of the replacement with a new model of central control unit, the replacement request may intervene before the disabling.

According to an aspect of the invention, the unique identifier of a central control unit may comprise for example a MAC address or a serial number. This identifier may be in the form of a QR (or QR-Code, standing for “Quick Response Code”) code or another barcode optically readable on the central control unit or the device or their packaging, or in the form of a radio frequency identification tag (or RFID, standing for “Radio Frequency IDentification”), a near field communication tag (or NFC, standing for “Near Field Communication”) or any other tag readable by a device available to the user, such as for example a mobile communication terminal.

According to an aspect of the invention, the step of determining at least one set of configuration data or instructions associated to the identifier of the second central control unit from the at least one set of configuration data or instructions associated to the unique identifier of the first central control unit comprises an at least partial copy of the at least one set of configuration data or instructions associated to the identifier of the first central control unit.

According to an aspect of the invention, the step of determining at least one set of configuration data or instructions associated to the identifier of the second central control unit from the at least one set of configuration data or instructions associated to the unique identifier of the first central control unit comprises a modification of a format of the configuration data or instructions or a modification of a structure of the configuration data or instructions.

Thanks to these arrangements, it is in particular possible to replace a first central control unit with a second central control unit of a type different than the first central control unit, for example in the case of an upgrade or of the use of a different hardware system.

As example, a change in the structure of the calendar information representation model may be taken into account: according to a first model, an event is represented with a weekly recurrence. According to a second model, an event may be represented with a recurrence expressed according to complementary parameters, such as a day of the month or the number of the week in the month. The more sophisticated second model may express the event expressed according to the first model, after a structure modification. Functionally, the result is the same.

The new functions offered by the second model may be configured by default.

According to an aspect of the invention, the step of determining at least one set of configuration data or instructions associated to the identifier of the second central control unit from the at least one set of configuration data or instructions associated to the unique identifier of the first central control unit comprises an adaptation of the configuration data or instructions.

According to an aspect of the invention, the adaptation of the at least one set of configuration data or instructions concerns an emission or reception address or a unique identifier which should be replaced in the at least one set of configuration data or instructions.

According to an aspect of the invention, the step of determining at least one set of configuration data or instructions associated to the identifier of the second central control unit from the at least one set of configuration data or instructions associated to the unique identifier of the first central control unit may be carried out prior to the configuration request step, after the replacement request. Alternatively, said determination step may be carried out subsequently to the replacement request.

According to an aspect of the invention, the method further comprises the following step:
Registration of the at least one set of configuration data or instructions associated to the identifier of the second central control unit in the configuration repository.

According to an aspect of the invention, the method further comprises the following step:
Update of the configuration repository so as to register the effective replacement of the first central control unit with the second central control unit.

According to an aspect of the invention, the method comprises a step consisting in suppressing or invalidating the record corresponding to the ancient central control unit in the configuration repository.

According to an aspect of the invention, the update comprises the steps of updating the elements that referred to the first central control unit to replace said reference with a reference to the second central control unit.

In particular, the update may comprise an update of a repository of installations; and/or an update of a repository of home automation devices and/or an update of a repository of scenarios.

According to an aspect of the invention, the method further comprises the following step:
Check-up of the availability of the unique identifier of the second central control unit before the configuration repository;

The check-up step being prior to the registration of the replacement request.

The recognition of the availability of the identifier may be a requisite for the registration of the replacement request. If the availability of the unique identifier before the configuration repository is not recognized, this means that the subscription request cannot be addressed because the second central control unit is already associated to a configuration and/or to an installation. Hence, a conflict concerning this identifier should be solved.

According to an aspect of the invention, the method further comprises a step of checking up the existence and the rights of the user corresponding to the identifier before a user repository.

The recognition of the validity of the user account is a requisite for the configuration or the replacement of the central control unit. Otherwise, this means that the subscription request cannot be addressed because the associated user account on the service is not valid or does not exist. Hence, a valid user account on this service should be determined before resuming the replacement.

The present invention also concerns a method for configuring a central control unit belonging to a home automation installation or to a home automation device comprising a central control unit and belonging to a home automation installation, in the context of the replacement of a previous central control unit, the method being implemented by the central control unit and comprising the following steps:
Obtainment of a location identifier of a configuration service;
Sending a configuration request to the configuration service using the location identifier and linked to an identifier of the central control unit;
Reception of at least one set of configuration data or instructions originating from the first configuration remote service derived from the configuration of the previous central control unit;
Configuration of the central control unit on the basis of the at least one set of configuration data or instructions.

According to an aspect of the invention, the configuration step comprises a configuration of at least one emission and/or reception address of the central control unit used for a communication interface with a home automation device of the home automation installation, the configuration being carried out on the basis of at least one emission and/or reception address value comprised in the at least one set of configuration data or instructions.

According to an aspect of the invention, the configuration step comprises the sending of a control message to at least one home automation device for the modification of an emission and/or reception address used by a communication interface of the home automation device with the central control unit of the home automation installation, on the basis of at least one emission and/or reception address value comprised in the at least one set of configuration data or instructions.

The different non-incompatible aspects defined hereinabove may be combined.

### BRIEF DESCRIPTION OF THE FIGURES

The invention will be better understood from the detailed description which is exposed hereinafter with reference to the appended drawing in which:

FIG. 1 is a schematic view of a building and of a home automation installation in accordance with an embodiment of the invention;

FIG. 2 is a diagram presenting an architecture of a system comprising the home automation installation illustrated in FIG. 1, a second home automation installation, as well as a plurality of servers intended to be connected to the home automation installations;

FIG. 3 is a diagram illustrating an implementation of a configuration method;

FIG. 4 illustrates details of configuration of the communication interfaces of a central control unit and of a home automation device.

### DESCRIPTION WITH REFERENCE TO THE FIGURES

In the following detailed description of the figures defined hereinabove, the same elements or the elements filling identical functions may preserve the same references so as to simplify the understanding of the invention.

### Description of a System Comprising a Home Automation Installation

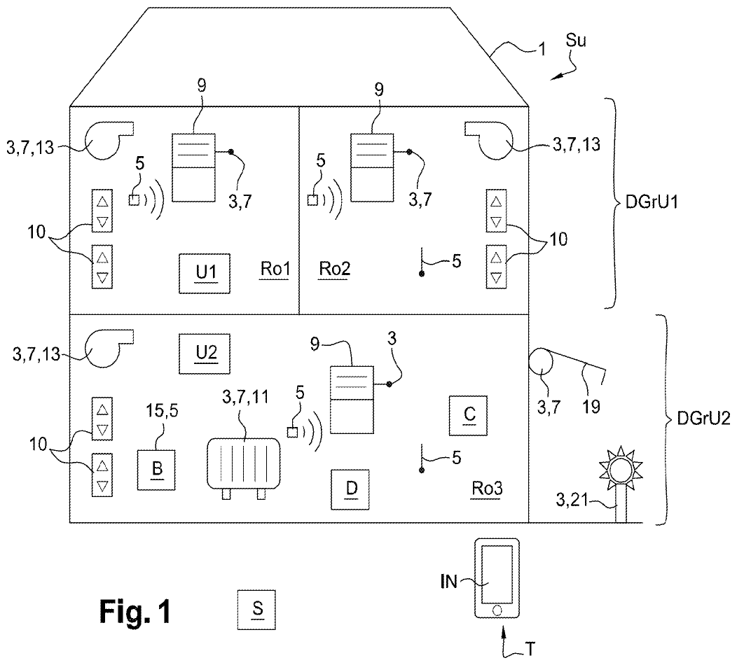

As illustrated in FIG. 1, a building 1 comprises for example three rooms Ro1, Ro2, Ro3. The building 4 also comprises home automation equipment 3 and sensors 5.

A home automation equipment 3 may consist of an actuator arranged to displace or set an element of the building 1, for example an actuator 7 for displacing a rolling shutter 9 or a terrace awning 19, or a regulation system 10 for a heater 11 or a ventilation system 13. A home automation equipment 3 may also consist of a lighting, for example a terrace external lighting 21 or a lighting control system, an alarm system, or still a video camera, in particular a video-surveillance camera.

The home automation installation Su may also comprise a control point 15 an actuator 7, such as a wireless control box B for the rolling shutter 9.

The home automation installation Su may comprise one or several sensor(s) 5, integrated to an actuator 7, to a control point 15 or to the control box B or independently of these elements. In particular, a sensor 5 may be arranged to measure a physical unit, for example a temperature sensor, an insulation sensor or a humidity sensor. Position sensors 5 of home automation equipment 3 of the building 1, such as, for example, sensors of the open state of a rolling shutter 9 or sensors of the position of a door leaf such as a window, whether motorized or not, may also be provided. The home automation installation may also comprise one or several presence sensor(s). The installation may also comprise one or several electric consumption sensor(s).

A home automation equipment 3 and a sensor 5 should thus be considered as units having information on observed actual states of elements of the building 1 and being capable of sharing this information with other elements of the home automation installation Su.

The home automation equipment 3 and the sensors 5 can thus have access to any measurable physical unit, such as the temperature of each room Ro1, Ro2, Ro3 or a state of an element of the building 1, such as the open state of a rolling shutter 9, the state of an alarm, etc.

In the following, we will use the home automation device or device D designation indifferently to designate sensors or home automation equipment, or parts of home automation equipment 3 or sensors 5.

In general, the home automation devices comprise a processing unit comprising a processor executing an embedded software. This software undergoes updates to improve the functions thereof or to proceed with corrections.

The home automation installation Su comprises a central control unit or a plurality of central control units U1, U2. In particular and as example, two central control units U1, U2 are represented in FIG. 1. According to one variant, a home automation installation may also comprise one single central control unit.

Each central control unit U1, U2 is arranged to control and/or monitor part of the devices D of the installation Su forming a group DGrU1, DGrU2. As example, in FIG. 1, the central control unit U1 is in charge of the devices D disposed in the rooms Ro1 and Ro2 of the first floor of the building, whereas the central control unit U2 is in charge of the devices D disposed in the room Ro3 on the ground floor of the building and the external devices.

In particular, the control and/or monitoring is carried out remotely, in particular using a wireless communication protocol, for example a radio communication protocol. Each central control unit U1, U2 is arranged to group together all data originating from the devices D of its group DGrU1, DGuU2 and to process these data.

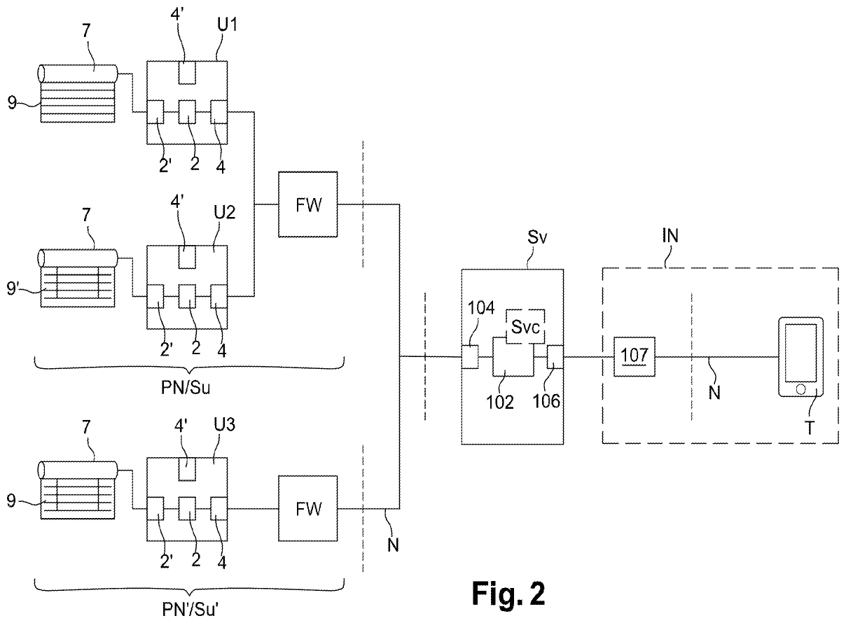

As represented in FIG. 2, each central control unit U is arranged to communicate with one or several remote server(s) Sv.

The central control units U1, U2, U3 are disposed on a private network PN, PN′, whose access is generally protected by a firewall FW. In particular, in the example represented in FIG. 2, two central control units U1, U2 are disposed on a first private network corresponding to a first home automaton installation, while a third central control unit U3 is disposed on a second private network PN′, independent of the private network PN corresponding to a second home automation installation Su′. The private network PN is linked to a wide area network N, for example the Internet. We will describe in the following one of these units.

A central control unit U comprises a processing unit 2 arranged to contain and execute a first computer program. As example, the processing unit 2 comprises a processor, a storage flash memory as well as a random access memory, and an Ethernet chip.

The processing unit executes an embedded software. This software undergoes updates to improve the functions thereof or to proceed with corrections.

The central control unit U further comprises at least one communication module 2′ intended to monitor and/or control home automation equipment 3 and/or sensors 5, the home automation equipment 3 may consist of actuators 7, lightings 21, an alarm system, or a video camera.

As example, as represented in FIG. 2, the communication module 2′ enables the monitoring and control of at least one actuator 7, a movable element of the building 1, such as for example a rolling shutter 9, or an orientable sunshade 9′ or other actuators 7 or lightings 21, as previously described with reference to FIG. 1, according to at least one local communication protocol.

As example, the communication module 2′ may be arranged to implement for example one or more of the local first protocols P1 such as for example Z-Wave, EnOcean, io-Homecontrol, Somfy RTS, KNX, MODBUS, Wavenis, Philips HUE. In general, these local first protocols are non-IP local communication protocols.

According to another possibility, for example in the context of alarm systems, the central control unit may be integrated into the home automation device. According to still another possibility, the central control unit may also be integrated to a router and/or a modem achieving a connection to a wide area network, in particular the Internet.

When the central control unit is integrated to a home automation device, the communication module 2′ intended for the monitoring and/or control of the device may be a communication module internal to the home automation device and/or a communication module intended for the monitoring and/or control of other home automation devices.

There is also provided the reception of information from a sensor 5 providing information on the presence of a user or values of the surrounding parameters such as temperature, humidity and luminosity. In the same manner, the central unit U may enable the monitoring and/or control of an alarm system.

Each central control unit U may further comprise a communication module 4′ for communicating according to a communication protocol other than the local first protocol. For example, the second communication protocol may be a communication protocol above the IP protocol on a local area network, or else a generic point-to-point protocol. As example, the application protocol WEAVE using transport protocols 6lowpan and thread for a mesh network may constitute a second protocol. Other examples include Bluetooth, Zigbee or Wifi.

The communication terminal T may contain and execute an application software APP.

Each central control unit U further comprises a module 4 for communication with remote servers Sv1i, Sv1c, Sv2.

The server Sv enables the remote control and/or monitoring and comprises one or several processing unit(s) 102 arranged to contain and execute a second computer program.

In some applications, a central control unit U may communicate with the server Sv through an intermediate server, for example a third-party service provider, whose intermediate server provides a service interface or API. In turn, the server Sv comprises at least one communication interface 104 intended for the communication with the central unit U.

The server Sv may also comprise a communication interface 106 intended for the communication with a control and/or monitoring interface IN enabling an end user Usr1 to remotely monitor the home automation installation, in particular via a configuration remote service Svc.

It should be noted that the term server is a logical designation which may cover the use of several physical servers to distribute the computer processing load to be carried out.

For example, the control and/or monitoring interface IN comprises a web server 107 and a mobile communication terminal T1 communicating via the wide area network N. For example, the mobile communication terminal T1 may consist of a smartphone or a tablet. The mobile communication terminal T1 may be the same or a terminal of the same type as that with which the central control unit U communicates locally by means of the communication module 4′, or a different terminal. We will designate these mobile terminals indifferently by the reference T1. Alternatively, the end user may also use a stationary terminal.

The control and/or monitoring interface IN comprises a processor which may be disposed at the level of the web server 107 and/or the mobile communication terminal T1.

The processor of the control and/or monitoring interface IN is arranged to use a third computer program. In turn, this third computer program is arranged to execute a downloadable application.

The mobile communication terminal T comprises a data input device and a display device, for example in the form of a tactile control portion of a screen of the terminal T and in the form of one or several button(s) of the terminal T.

Unique Identifier of a Home Automation Device

The server Sv, the configuration service Svc as well as the central control units U may use a unique identifier to identify the home automation devices. The structure of a unique identifier of a home automation device DURL will now be described in connection with a particular embodiment.

According to this embodiment, the unique identifier of a home automation device comprises information on:
The local native protocol of the home automation device D;
The communication path to the device D, including the intermediate central control units U and the termination addresses to cross, whether organized or not in a hierarchical topology;
A subsystem identifier subsystemId if the device belongs to a group of devices D associated to the same address. The devices that are a unique expression of an address have no extension for identifying a subsystem.

Thus, the form of the unique identifier of a device DURL may be as follows:

<protocol>://<gatewayId>/<rawDeviceAddress>(#<subsystemId>)

Wherein the following fields are present:

protocol: identifier of the native device local protocol.

gatewayId: identifier of the first central control unit U, for example a serial number or a unique identifier.

rawDeviceAddress: a simple or multi-level path. Its meaning and its format depend on the addressing scheme of the local communication protocol of the device D.

subsystemId: this optional field indicates an identification, for example a rank of the subsystem (starting for example at 1), if such a subsystem is present.

### EXAMPLES

1) knx://0201-0001-1234/1.1.3

This unique identifier DURL corresponds to a device D communicating by the KNX procotol with an individual address 1.1.3 accessible to the central control unit U carrying the identifier #0201-0001-1234.

2) io://0201-0001-1234/145036#2

This unique identifier GDURL corresponds to a subsystem carrying the number 2 associated to a device D communicating by the io-Homecontrol protocol with a radio address 145036 accessible to the central control unit U carrying the identifier #0201-0001-1234.

Configuration Service

The configuration service Svc is intended to identify the correct technical configuration for the home automation device or the considered central control unit and to communicate configuration data and/or instructions to the central control unit U.

This service may be a remotely-accessible computerized service, which enables access to at last one control or supervision function of a home automation installation or of a home automation device, by means of a user interface or an application. The user interface may be accessible by a graphical interface, or through a programming interface.

Configuration Repository

The configuration service Svc implements a configuration repository Rf. The configuration repository Rf stores the correspondence between an identifier of a central control unit UID and configuration data relating to this central control unit Cfg. Moreover, this repository may contain a link Lk between a first central control unit and a second central control unit intended to replace the first one. An initialization specific value FI may also be associated to a central control unit U1′ to indicate that this central control unit U1′ has to be configured.

The Table 1 hereinbelow provides an example of a first data structure of the repository Rf.

TABLE 1
Example of a second data structure of the repository Rf

| Identifier of a central | | | |
|---|---|---|---|
| control unit UID | Link Lk | Initialization Fl | Configuration cfg |
| U1ID | — | N | Cfg |
| U1′ID | U1ID | Y | Cfg′ |

As example, the repository may be constituted by a data base or a depository service. This repository may be comprised in the first configuration service Svc1 or external and accessible by the first configuration service Svc1.

Configuration Method

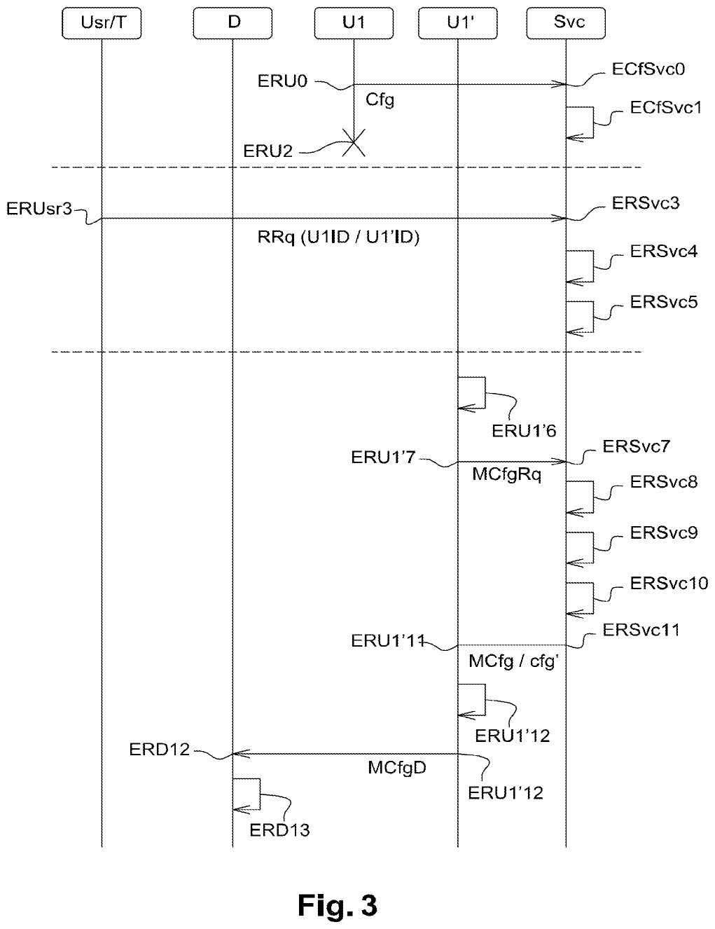

We will now describe a configuration method in the context of the replacement of a central control unit U1 belonging to a home automation installation Su with reference to FIG. 3.

In a phase prior to the replacement method corresponding to a step ERU0 in FIG. 3, the central control unit U1 communicates its configuration cfg in the form of at least one set of configuration data and/or instructions to the configuration service Svc which receives this at least one set at a step ERSvc0. At a step ERSvc1, the configuration service Svc stores said configuration in a configuration repository Rf, linked to a central control unit unique identifier.

These steps may be carried out at will during a backup operation carried out at the end of the configuration of the central control unit U1, and/or periodically with updates of the stored data. It is also possible that these steps are possibly initiated before a replacement in the case of installation of a new hardware version (upgrade).

As indicated in FIG. 3, we will suppose at step ERU2 that a failure or a disabling of the central control unit U1 occurs. The disabling may correspond to an expected installation of a new model of central control unit U1′.

Afterwards, the user Usr proceeds with a replacement of the central control unit U1 with a new central unit U1′. Next, the central control unit U1 to be replaced will be called “ancient central control unit” or “first central control unit”. The replacement central control unit U1′ will be called “new central control unit” or “second central control unit”.

The new central control unit U1′ contains at least one location identifier SvcL corresponding to an information relating to the address of the configuration service Svc. This identifier may be stored in the memory during a pre-configuration, for example carried out in factory. Alternatively, this identifier may be communicated by the user.

At a step ERUsr3, the user emits, for example through a user terminal T, a replacement request RRq to the configuration remote service Svc which receives it at a step ERSvc3. This request contains the identifier U1ID of the ancient central control unit U1 and the identifier U1′ID of the new central control unit U1′. In the case of the replacement with a new model of central control unit, the replacement request may intervene before the disabling.

At a step ERSvc4, the configuration service Svc proceeds with a check-up before the configuration repository Rf in order to identify whether the identifier U1′ID of the new central control unit U1′ is available in the repository. In this case, we will suppose that the availability of the identifier U1′ID has been recognized. Otherwise, this means that the subscription request cannot be addressed because the new central control unit U1′ is already associated to a configuration and to an installation. Hence, a conflict concerning this identifier should be solved.

At this level, the method may further comprise a step of checking up the existence and the rights of the user corresponding to the identifier of the new central control unit U1′ before a user repository.

The recognition of the validity of the user account is a requisite for the configuration or the replacement of the central control unit U1. Otherwise, this means that the subscription request cannot be addressed because the associated user account on the service is not valid or does not exist. Hence, a valid user account on this service should be determined before resuming the replacement.

At a step ERSvc5, the service proceeds with a registration ERSvc5 in the configuration repository Rf of the identifier of the new central control unit U1′, linked Lk to the ancient central control unit U1, in order to define the association between the ancient central control unit U1 or its identifier U1ID on the one hand and the new central control unit U1′ or its identifier U1′ID on the other hand. An initialization specific value FI may also be associated to the new central control unit U1′ to indicate that this new central control unit U1′ has to be configured.

At this level, at step ERSvc5, the configuration service Svc may determine all or part of at least one set of configuration data or instructions cfg′ associated to the identifier of the new central control unit U1′ in order to store this set in the configuration repository Rf. The determination steps are detailed later on with reference to step ERSvc10.

Next, it is proceeded with a plugging and/or initialization of the new central control unit U1′. This plugging/initialization may be trigged by an electric power supply or by an order originating from an instruction of the user through a physical action on the new central control unit U1′ such as a press on a button or a sending of instruction via a terminal T.

In the context of this plugging or following this initialization, the new central control unit U1′ obtains, at a step ERU1′6, the location identifier SvcL of the configuration service which may correspond to an URL, this identifier having been stored beforehand in the memory of the new central control unit U1′.

At a step ERU1′7, the new central control unit U1′ sends a configuration request MCfgRq which is received by the configuration service Svc at a step ERSvc7. This configuration request MCfgRq identifies the new central control unit U1′ by the identifier U1′ID. This configuration request may correspond to a simple connection attempt. Of course, several successive steps may be carried out corresponding to the establishment of a communication, then to the configuration request.

According to another implementation, the configuration request may originate from the user via a terminal T. Following the plugging/initialization of the new central control unit U1′, the user can connect on the configuration service Svc and triggers the replacement of the ancient central control unit U1 with the new central control unit U1′ by providing the two identifiers U1ID, U1′ID of the ancient and of the new central control unit.

On reception of this configuration request, the configuration service Svc proceeds with a check-up at a step ERSvc8 in the configuration repository Rf in order to determine whether the identifier U1′ID of the new central control unit is actually assigned, and which are the associated data.

Following this check-up, one or several configuration step(s) are carried out by the configuration service Svc represented together in FIG. 3 by step ERSvc9. In particular, these steps consist in suppressing or invalidating the record corresponding to the ancient central control unit U1.

These steps also comprise the steps consisting in updating the elements that referred to the ancient central control unit U1 to be replaced with a reference to the new central control unit U1′:

a) Possibly updating a repository of the installations Su, so as to replace the references to the ancient central control unit U1 with references to the new central control unit U1′,

b) Updating a repository of the home automation devices ID, in particular DURL;

c) Updating a repository of the control scenarios.

The initialization specific value FI associated to the new central control unit U1′ may be updated to indicate that this new central control unit U1′ is configured.

At a step ERSvc10, the configuration service Svc proceeds with the determination and/or the collection of the at least one set of configuration data or instructions cfg′ associated to the identifier of the ancient central control unit U1′ in particular from the at least one set of configuration data or instructions cfg associated to the identifier of the ancient central control unit U1 and comprised in the configuration repository.

This determination step may comprise a partial or full copy of the at least one set of configuration data or instructions cfg associated to the identifier of the ancient central control unit U1.

This step may possibly comprise a step of converting the configuration cfg if the new central control unit U1′ is not of the same type as the ancient central control unit U1, for example in the case of an upgrade or of the use of a different hardware system. It is also possible to proceed with adaptations of the configuration, for example when an address or a unique identifier should be replaced in the configuration cfg. As example, this situation may correspond to a configuration portion concerning an electronic key (also known as “dongle”) connected to the new central control unit U1′.

All or part of the determination steps may be carried out beforehand during step ERSvc5, step ERSvc10 may be restricted to a collection of the set cfg′ available in the configuration repository Rf.

Afterwards, the configuration service Svc can send one or several configuration message(s) MCfg at a step ERSvc11 which are received by the new central control unit U1′ at a step ERU1′11.

At a step ERU1′12, the new central control unit U1′ proceeds with its configuration on the basis of the information received from the service in the message MCfg.

In particular, this configuration concerns the modification of the emission and reception addresses of the new central control unit U1′.

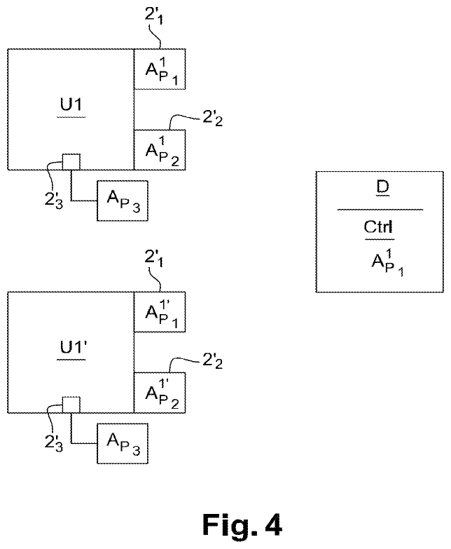

As illustrated in FIG. 4, the ancient central control unit U1 has, for example, two communication interfaces 2₁′ and 2₂′ intended for the communication respectively according to a first protocol P₁ and according to a local second protocol P₂. The ancient central control unit U1 is identified by an address A_{P}_{₁}¹ according to the first protocol and respectively by an address A_{P}_{₂}¹ according to the second protocol.

We will suppose that the new central control unit U1′ comprises the same communication interfaces 2₁′ and 2₂′ intended for the communication respectively according to a first protocol P₁ and according to a local second protocol P₂. The ancient central control unit U1 is identified by an address A_{P}_{₁}¹ according to the first protocol and respectively by an address A_{P}_{₂}¹ according to the second protocol.

A home automation device D which is related to the ancient central control unit U1, such as for example a lamp, and communicating with the ancient central control unit U1, may have stored the address A_{P}_{₁}¹ in a list of controllers, for example in order to be able to send notifications to the ancient central control unit U1.

In this configuration, during the configuration step ERU1′12, in order to enable a direct communication between the device D and the new central control unit U1′, the value of the address A_{P}_{₁}¹ is assigned to the address A_{P}_{₁}¹′. This address value is part of the configuration cfg stored in the repository Rf by the configuration service Svc, and is communicated in the configuration messages Mcfg.

According to a second possibility, to the extent that the device D provides an interface enabling such an update, it is possible for the new central control unit U1 to send a configuration message MCfgD to the device D at a step ERU1′12, this message comprising an instruction for modification in the list of controllers Ctrl of the address A_{P}_{₁}¹ into an address A_{P}_{₁}¹′. The home automation device D receives this configuration message MCfgD at a step ERD12, and performs the corresponding configuration at a step ERD13.

FIG. 4 illustrates an additional possibility according to which a communication interface 2₃′ is made by a dongle or another hardware element connected on a port of the new central control unit, for example a USB port.

The new central control unit U1′ can proceed at step ERU1′12 with the configuration of removable peripherals if the removable peripheral has a memory allowing permanent storage of the configuration data and if it enables an automatic configuration by the new central control unit U1′. It should be checked up whether the removable peripheral is a new peripheral or a peripheral previously related to the ancient central control unit that has been replaced. In order to carry out this check-up, it is possible to proceed with a check-up of the address or serial number or with a check-up of the connected products and compare these elements with the records stored on the management unit, if the configuration information of the peripheral have been kept and stored on the server like the configuration data of the ancient central control unit U.

As example, the removable peripheral may be component or an electronic key for communication according to the Zwave protocol. In the context of a Mesh network communication, the electronic key may take care of the management of the routes (Zwave). In this case, it is possible to keep the electronic key during the change of central control unit in order to preserve the configuration, or replicate the data on a new electronic key if the corresponding configuration has been stored on the management unit.

1. A method for configuring a second central control unit belonging to a home automation installation, in the context of the replacement of a first central control unit, the method being implemented by a first configuration remote access service executed by a management unit and comprising the following steps:
registration of at least one set of configuration data or instructions associated to a unique identifier of a first central control unit;
reception of a configuration request linked to an identifier of a second central control unit;
determination of an association between the second central control unit or its identifier on the one hand and the first central control unit or its identifier on the other hand;
determination of at least one set of configuration data or instructions associated to the identifier of the second central control unit from the at least one set of configuration data or instructions associated to the unique identifier of the first central control unit; and
sending at least one configuration message comprising the at least one set of configuration data or instructions associated to the identifier of the second central control unit to the second central control unit.

2. The configuration method according to claim 1, wherein the at least one set of configuration data or instructions associated to the identifier of the second central control unit comprises at least one datum or instruction for configuring at least one emission and/or reception address of the second central control unit used for a communication interface with a home automation device of the home automation installation.

3. The configuration method according to claim 1, wherein the at least one set of configuration data or instructions associated to the identifier of the second central control unit comprises at least one datum or instruction for configuring an emission and/or reception address used by a communication interface of a home automation device related to the central control unit of the home automation installation.

4. The configuration method according to claim 1, further comprising the following steps:
reception of a replacement request in connection with an identifier of the first central control unit and an identifier of the second central control unit;
registration in a configuration repository of an association between the first central control unit or its identifier on the one hand and the second central control unit or its identifier on the other hand.

5. The configuration method according to claim 1, wherein the step of determining at least one set of configuration data or instructions associated to the identifier of the second central control unit from the at least one set of configuration data or instructions associated to the unique identifier of the first central control unit comprises an at least partial copy of the at least one set of configuration data or instructions associated to the identifier of the first central control unit.

6. The configuration method according to claim 1, wherein the step of determining at least one set of configuration data or instructions associated to the identifier of the second central control unit from the at least one set of configuration data or instructions associated to the unique identifier of the first central control unit comprises a modification of a format of the configuration data or instructions or a modification of a structure of the configuration data or instructions.

7. The configuration method according to claim 1, wherein the step of determining at least one set of configuration data or instructions associated to the identifier of the second central control unit from the at least one set of configuration data or instructions associated to the unique identifier of the first central control unit comprises an adaptation of the configuration data or instructions.

8. The configuration method according to claim 4, further comprising the following step:
registration of the at least one set of configuration data or instructions associated to the identifier of the second central control unit in the configuration repository.

9. The configuration method according to claim 8, further comprising the following step:
update of the configuration repository so as to register the effective replacement of the first central control unit with the second central control unit.

10. The configuration method according to claim 4, further comprising the following steps:
check-up of the availability of the unique identifier of the second central control unit before the configuration repository;
the check-up step being prior to the registration of the replacement request.

11. A method for configuring a central control unit belonging to a home automation installation or to a home automation device comprising a central control unit and belonging to a home automation installation, in the context of the replacement of a previous central control unit, the method being implemented by the central control unit and comprising the following steps:
obtainment of a location identifier of a configuration service;
sending a configuration request to the configuration service using the location identifier and linked to an identifier of the central control unit;
reception of at least one set of configuration data or instructions originating from the first configuration remote service derived from the configuration of the previous central control unit;
configuration of the central control unit on the basis of the at least one set of configuration data or instructions.

12. The configuration method according to claim 11, wherein the configuration step comprises a configuration of at least one emission and/or reception address of the central control unit used for a communication interface with a home automation device of the home automation installation, the configuration being carried out on the basis of at least one emission and/or reception address value comprised in the at least one set of configuration data or instructions.

13. The configuration method according to claim 11, wherein the configuration step comprises the sending of a control message to at least one home automation device for the modification of an emission and/or reception address used by a communication interface of the home automation device with the central control unit of the home automation installation, on the basis of at least one emission and/or reception address value comprised in the at least one set of configuration data or instructions.

14. The configuration method according to claim 2, wherein the at least one set of configuration data or instructions associated to the identifier of the second central control unit comprises at least one datum or instruction for configuring an emission and/or reception address used by a communication interface of a home automation device related to the central control unit of the home automation installation.

15. The configuration method according to claim 14, further comprising the following steps:
reception of a replacement request in connection with an identifier of the first central control unit and an identifier of the second central control unit;
registration in a configuration repository of an association between the first central control unit or its identifier on the one hand and the second central control unit or its identifier on the other hand.

16. The configuration method according to claim 15, wherein the step of determining at least one set of configuration data or instructions associated to the identifier of the second central control unit from the at least one set of configuration data or instructions associated to the unique identifier of the first central control unit comprises an at least partial copy of the at least one set of configuration data or instructions associated to the identifier of the first central control unit.

17. The configuration method according to claim 16, wherein the step of determining at least one set of configuration data or instructions associated to the identifier of the second central control unit from the at least one set of configuration data or instructions associated to the unique identifier of the first central control unit comprises a modification of a format of the configuration data or instructions or a modification of a structure of the configuration data or instructions.

18. The configuration method according to claim 17, wherein the step of determining at least one set of configuration data or instructions associated to the identifier of the second central control unit from the at least one set of configuration data or instructions associated to the unique identifier of the first central control unit comprises an adaptation of the configuration data or instructions.

19. The configuration method according to claim 18, further comprising the following step:
registration of the at least one set of configuration data or instructions associated to the identifier of the second central control unit in the configuration repository.

20. The configuration method according to claim 19, further comprising the following step:
update of the configuration repository so as to register the effective replacement of the first central control unit with the second central control unit.
